(19) United States
(12) Patent Application Publication
(10) Pub. No.: US 2011/0087963 A1
(43) Pub. Date: Apr. 14, 2011

(54) User Interface Control with Edge Finger and Motion Sensing

(75) Inventors: Arthur Richard Brisebois, Cumming, GA (US); Robert S. Klein, Manchester, CT (US)

(73) Assignee: AT&T MOBILITY II LLC, Atlanta, GA (US)

(21) Appl. No.: 12/576,419

(22) Filed: Oct. 9, 2009

(51) Int. Cl. G06F 3/041

(52) U.S. Cl. 715/702; 345/173; 715/863; 715/784

(57) ABSTRACT

Devices and methods are disclosed which relate to controlling the interface of a communications device using edge sensors that detect finger placement and movements. The invention combines edge sensors and outputs with left/right hand detection and an associated soft key adaptation. This combination allows a user to make handset inputs, such as display control functions, on the interface using finger placement combinations and motions. The approach may be applied to communications devices such as cellular telephones, PDAs, Tablet PCs, etc. as well as other handheld devices including, but not limited to, those used for GPS, package tracking and musical instruments. The combination user interface approach may be applied to any soft keys, on either side or edge of the device, for any function.

### BACKGROUND OF THE INVENTION

1. Field of the Invention

The present invention relates to communications devices. More specifically, the present invention relates to controlling the user interface of a communications device.

2. Background of the Invention

Communications devices, such as cellular phones, have become a common tool of everyday life. Cellular phones are no longer simply used to place telephone calls. With the number of features available rapidly increasing, cellular phones are now used for storing addresses, keeping a calendar, reading e-mails, drafting documents, viewing maps, etc. These devices are small enough that they can be carried in a pocket or purse all day, allowing a user to stay in contact almost anywhere. Recent devices have become highly functional, providing applications useful to business professionals as well as the casual user.

As devices and applications become more complex, so do the input requirements for their use. Handheld device input mechanisms are typically based upon single finger contact with mechanical or soft key controls. This places a severe limitation on the range of inputs, ease of use, and handset space constraints. Often, performing a function requires a series of steps. For example, when viewing a map on a communications device, a user may wish to scroll to a portion of the map or zoom in. These functions often require scrolling through menus or other complicated or time consuming methods. Other options include touch screens and “multi-touch” technology. While these methods are an improvement, they are not always ideally suited to handset form factors, price points, or device manufacturer diversity interests (due to Intellectual Property Rights (IPR) issues).

These limitations have material impact upon the usefulness and variety of handset applications and manufacturers in the marketplace. What are needed are devices and methods that allow a user to easily control an interface with a variety of functions on a communications device.

### SUMMARY OF THE INVENTION

The present invention provides devices and methods for controlling the interface of a communications device using edge sensors that detect finger placement and movements. The invention combines edge sensors and outputs with left/right hand detection and an associated soft key adaptation. This combination allows a user to make handset inputs, such as display control functions, on the interface using finger placement combinations and motions.

The approach may be applied to communications devices such as cellular telephones, PDAs, Tablet PCs, etc. as well as other handheld devices including, but not limited to, those used for GPS, package tracking, and musical instruments. The combination user interface approach may be applied to any soft keys, on either side or edge of the communications device, for any function.

This solution optimizes the user-friendliness of communications devices from a tactile input perspective. Additional input points and options enable complex applications of functions otherwise impractical for handheld devices. In embodiments of the invention, the flexibility of this input approach is used to support adaptation to user limitations, specifically for the disabled.

In an exemplary embodiment of the present invention, the invention is a communications device with an interface controllable by edge and finger sensing, including a processor, a memory in communication with the processor, an accelerometer in communication with the processor, and an edge sensor in communication with the processor. The edge sensor detects a plurality of touches and motions by a user and compares the plurality of touches and motions with a stored set of touches and motions in the memory. A match between the plurality of touches and motions and the stored set of touches and motions results in an interface function.

In another exemplary embodiment of the present invention, the invention is a method for controlling an interface of a communications device, the method including determining an orientation of the communications device; touching a plurality of locations around an edge sensor of the communications device, wherein the plurality of locations and the orientation determines a control function; creating a motion along a sensor point; detecting the plurality of locations touched around the edge sensor and the motion along the sensor point; determining that the touches and the motion correspond to a valid control function; and adjusting a display according to the valid control function.

In a further exemplary embodiment of the present invention, the invention is a computer-readable medium containing instructions for controlling an interface of a communications device, the instructions including a first code segment for determining an orientation of the communications device; a second code segment for sensing a plurality of touches at a plurality of locations around an edge sensor of the communications device, wherein the plurality of locations and the orientation determines a control function; a third code segment for sensing a motion along a sensor point; a fourth code segment for detecting the plurality of locations touched around the edge sensor and the motion along the sensor point; a fifth code segment for determining that the touches and the movement correspond to a valid control function; and a sixth code segment for adjusting a display according to the valid control function.

### BRIEF DESCRIPTION OF THE DRAWINGS

FIGS. 1A and 1B show a communications device with an interface controlled by edge and finger sensing, according to an exemplary embodiment of the present invention.

FIGS. 2A and 2B show motions and positioning for vertical scrolling on a touchscreen of a communications device, according to an exemplary embodiment of the present invention.

FIGS. 3A and 3B show motions and positions for horizontal scrolling on a touchscreen of communications device, according to an exemplary embodiment of the present invention.

FIGS. 4A and 4B show motions and positions for zooming in on a touchscreen of communications device, according to an exemplary embodiment of the present invention.

FIGS. 5A and 5B show motions and positions for zooming in on a touchscreen of communications device, according to an exemplary embodiment of the present invention.

FIG. 6 shows motions and positions for scrolling on a touchscreen of communications device, according to an exemplary embodiment of the present invention.

FIG. 7 shows motions and positions for scrolling and zooming in on a touchscreen of communications device, according to an exemplary embodiment of the present invention.

FIG. 8 shows a method of controlling a user interface, according to an exemplary embodiment of the present invention.

### DETAILED DESCRIPTION OF THE INVENTION

The present invention provides devices and methods for controlling the interface of a communications device using edge sensors that detect finger placement and motions. The invention combines edge sensors and outputs with left/right hand detection and an associated soft key adaptation. This combination allows a user to make handset inputs, such as display control functions, on the interface using finger placement combinations and motions. The approach may be applied to communications devices such as cellular telephones, PDAs, Tablet PCs, etc. as well as other handheld devices including, but not limited to, those used for GPS, package tracking and musical instruments. The combination user interface approach may be applied to any soft keys, on either side or edge of the device, for any function.

This solution optimizes the user-friendliness of communications devices from a tactile input perspective. Additional input points and options enable complex applications of functions otherwise impractical for handheld devices. In embodiments of the invention, the flexibility of this input approach is used to support adaptation to user limitations, for instance, for the disabled. A memory on the communications device stores one or more user profiles which include input combinations for specific functions for specific users.

This solution uses, for example, the hand and finger sensing outputs of U.S. patent application Ser. No. 12/326,193 and the left/right hand sensing adaptation of U.S. patent application Ser. No. 12/326,172 to allow more complex inputs based upon finger combinations and movement. U.S. patent application Ser. No. 12/326,193 and U.S. patent application Ser. No. 12/326,172 are hereby incorporated by reference herein in their entirety. Using elements of these applications, the present disclosure introduces a variety of inputs as well as the ability to provide different interface control functions based upon these inputs. These interface control functions are created using a combination of user inputs. A variety of inputs are possible. For instance, the device of the present invention detects the presence of a user's hand, finger, stylus, etc. If a given sensing point on the edge sensor, for example, shows a change in capacitance, then a touch processor registers a contact on some point along the perimeter of the device. Contact, or a lack thereof, on any point along the edge is an indication that the device is, for example, either in or out of hand. The device also detects the location of a user's hand, finger, stylus, etc. Each sensing point on the device is numbered and has a known location along the sensing array of the edge sensor. When a specific sensing point shows a change in capacitance, the processor uses information detected by an edge sensor to ascertain the location of contact. This same sensing array detects the width or footprint of a touch. Sensing points are numerous and spaced closely together such that a typical finger or palm spans multiple sensing points. The touch and motion sensor looks for consecutive strings of contacted sensing points. The length of these consecutive sensing point strings is used to ascertain contact width and, for example, if the contact is from a finger, a palm or a thumb. The contact center is deemed to be at the middle point between the distant ends of the contacted sensing point string. This contact center is registered as the location being pressed.

The edge sensor detects the spacing of touches. Non-contacted sensing points span the gap between contacted sensing points. Small strings of non-contacted sensing points indicate close spacing. Long strings of non-contacted sensing points indicate distant spacing. This information is used to ascertain the relationship between contact points, for example, between thumb and palm versus adjacent fingers. Thus, different finger spacings may be utilized for different interface functions. The device also detects the count of touches. Each consecutive string of adjacent contacted sensing points indicates an object (finger, thumb, palm) touching the edge of the device. The edge sensor and processor use this information to ascertain the number of objects touching each edge of the device. Thus, for example, two adjacent fingers can be differentiated from one or three adjacent fingers.

Sensors on the device, such as edge sensors, detect the movement of touches on the device. Consecutive strings of contacted sensing points shift up and down if the object (finger, thumb or palm) is moved along the length of the sensor. The edge sensor uses this information to ascertain movement of any object touching the device edge.

Additionally, the device detects which hand of the user is holding the device. This allows for different input configurations based upon the hand holding the device. For instance, this determines if a specific soft key and input comes from the left or right side of the device. When the device is held in one hand, the placement of the user's fingers may be different than if the device is held in the user's other hand, for instance, by switching sensing points to the opposite side.

The device collects each of these simultaneously detected inputs and determines an inputted function. The correlation between finger placements/movements and functions is stored on a memory of the device such that detected inputs are compared with stored inputs in order to determine the function to be performed.

“Communications device” or “device,” as used herein and throughout this disclosure, refers to an electronic device which accepts an input from a touch sensor on the electronic device. Examples of a communications device include notebook computers, tablet computers, personal digital assistants (PDAs), cellular telephones, smart phones, GPS devices, package tracking devices, etc.

“Touchscreen,” as used herein and throughout this disclosure, refers to a display that can detect and locate a touch on its surface. Examples of types of touchscreen include resistive, which can detect many objects; capacitive, which can detect multiple touches at once; etc.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

These aforementioned outputs are used to assign/re-assign and act upon soft keys based upon various side finger/thumb contact and motion combinations. The various combinations are adapted to a user's left or right hand. Embodiments of the present invention match the most frequently used functions with the most natural hand positions to simplify use and avoid fatigue.

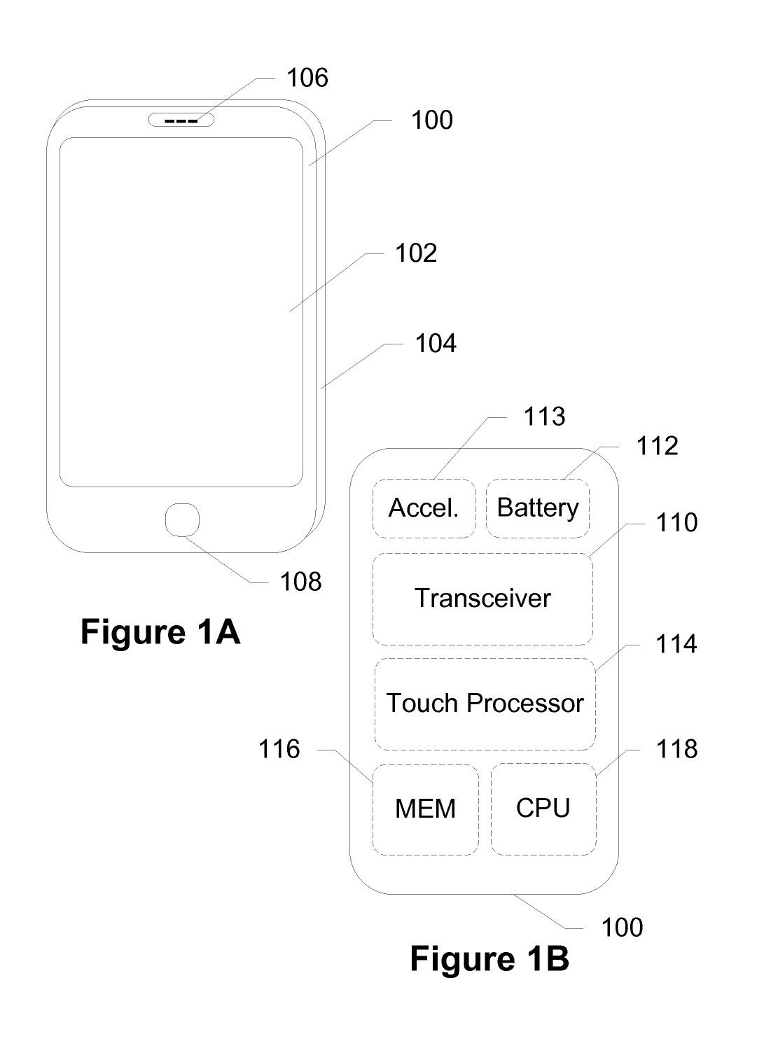

FIGS. 1A and 1B show a communications device 100 with an interface controlled by edge and finger sensing, according to an exemplary embodiment of the present invention. In this embodiment, communications device 100 includes a touchscreen 102, an edge sensor 104, a speaker 106, a microphone 108, a transceiver 110, a battery 112, an accelerometer 113, a touch processor 114, a central processing unit (CPU) 118, and a memory 116. Touchscreen 102 is an LCD or LED screen that is touch-sensitive such that a user can make selections or otherwise perform inputs on touchscreen 102. This allows the user to type letters, numbers, and symbols in order to create text messages, e-mails, etc. Touchscreen 102 also detects touches and motions by the user as interface controls. Edge sensor 104 is a plurality of sensors, or a sensor matrix dispersed around the edges of communications device 100. Edge sensor 104 may also be dispersed around the back of communications device 100. Edge sensor 104 allows communications device 100 to detect which hand is holding communications device 100, which fingers are touching edge sensor 104, what locations of edge sensor 104 are being touched, etc. Edge sensor 104 may utilize capacitive, resistive, touch sensitive, and/or any other suitable sensing technology to detect the presence and/or motion of a user's finger, stylus, etc. Edge sensor 104 may have a plurality of sensing points. A sensing point is a location with a specific correlated function. These inputs, as well as combinations of these inputs, are detected by edge sensor 104 and sent to touch processor 114 which determines a function activated by these inputs. Touch processor 114 notifies CPU 118 of these requested functions. CPU 118 instructs touchscreen 102 to display based upon these requested functions. For instance, if one of the inputs is a request to zoom in, touch processor 114 notifies CPU 118 that an area of touchscreen 102 should be zoomed in upon. CPU 118 instructs touchscreen 102 to zoom in on that area. CPU 118 also commands components of communications device 100 according to logic on memory 116. In embodiments of the present invention, CPU 118 incorporates touch processor 114. Accelerometer 113 measures the orientation of communications device 100. The orientation is used by CPU 118 to determine the view of an image on touchscreen 102, such as a portrait view or a landscape view, and may, along with touch inputs by edge sensor 104, determine interface controls. For instance, certain touch positions may have different interface controls based upon the orientation of communications device 100. Signals generated by accelerometer 113 may also be used by CPU 118 to detect motions of the device, such as for playing games, etc. Memory 116 stores logic, data, etc. This data includes interface functions correlated to a sequence of touches. Memory 116 also stores a plurality of user profiles. These user profiles include input combinations for specific functions for specific users. Transceiver 110 allows communications device 100 to wirelessly communicate with a network, other wireless devices, etc. Transceiver 110 may use cellular radio frequency technology (RF), BLUETOOTH, WiFi, radio-frequency identification (RFID), etc. Battery 112 stores an electric charge to power components of communications device 100.

There are many other embodiments of a communications device that use edge and finger sensing to control an interface. The embodiment in FIGS. 1A and 1B is similar to that of a cellular telephone or smart phone. Another exemplary embodiment is a PDA having a touchscreen. The feel is similar to that of FIGS. 1A and 1B since the size of the touchscreen is comparable. Another exemplary embodiment features a tablet computer with a touchscreen. A tablet computer typically has a much larger touchscreen than an average PDA and can accommodate, for instance, a full size soft keyboard or larger images. Further embodiments of the present invention use physical buttons instead of or in addition to edge sensors.

In embodiments of the present invention, edge sensors are used to determine the placement of a user's fingers around the edges of a communications device. The edge sensors detect presence, contact, location of touches, width of touches, spacing of touches, count of touches, movement of touches, etc. as described above. After the combination of presence and motions of touches is detected, the combination is compared with a combination stored on a memory of the communications device. The combination stored on the memory corresponds to an interface function. If the detected combination matches the stored combination, a processor on the communications device instructs the touchscreen according to the interface function.

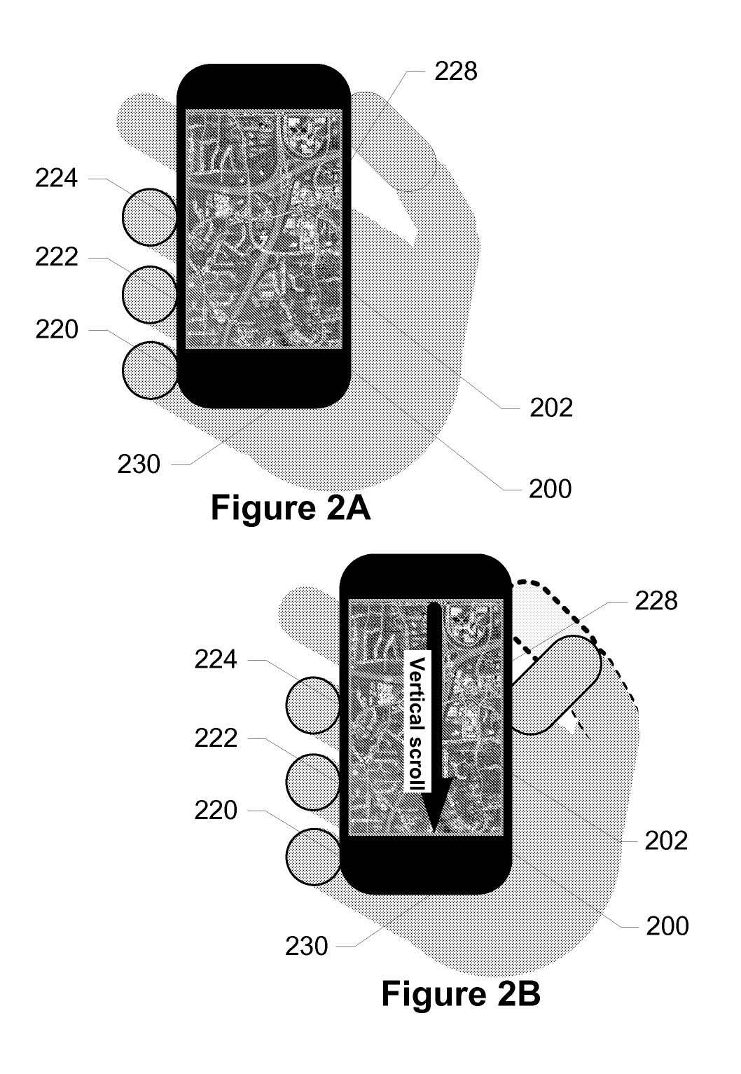

FIGS. 2A and 2B show motions and positioning for vertical scrolling on a touchscreen 202 of a communications device 200, according to an exemplary embodiment of the present invention. In this embodiment, a user is holding communications device 200 in the user's right hand. Edge sensors around the edge of communications device 200 detect fingers on the left side of communications device 200. Further, it is detected that communications device 200 is in the portrait mode orientation, using signals generated by an accelerometer in communications device 200. Additionally, communications device 200 detects the user's palm with sensor 230 at the bottom of communications device 200. These placements help communications device 200 determine the hand being used.

In order to vertically scroll on touchscreen 202, the user presses three of their fingers against the left side of communications device 200 at sensing points 220, 222, and 224. Sensing points 220, 222, and 224 are specific areas of the edge sensors of communications device 200. To scroll, the user moves their thumb downward along sensor point 228 of the edge sensor on the right side of communications device 200 for a downward scroll or upward along sensor point 228 of the edge sensor on the right side of communications device 200 for an upward scroll. The vertical scroll change is proportional to the distance the thumb has been moved along sensor point 228 of the edge sensor. The presence of fingers may be differentiated from finger presses based upon the amount of pressure applied, the location of the presses as determined by the edge sensors, sensor points, etc.

If the user is holding the communications device in their left hand, the communications device similarly detects this based upon the placement of the user's fingers. With the device in the user's left hand, the finger placement for vertical scrolling is the same, but with positions and motions on the left side moved to the right side, and vice versa. Thus, sensing points 220, 222, and 224 would be moved to the right side of communications device 200 and sensing point 228 would be moved to the left side of communications device 200.

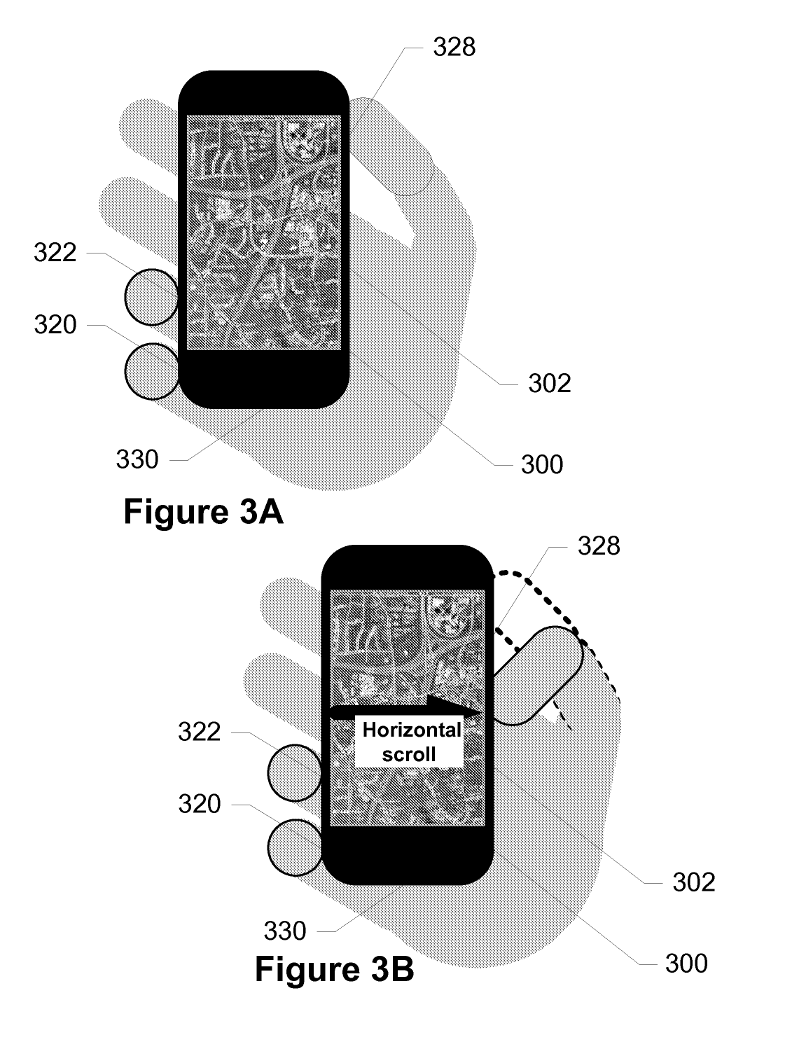

FIGS. 3A and 3B show motions and positions for horizontal scrolling on a touchscreen 302 of communications device 300, according to an exemplary embodiment of the present invention. In this embodiment, a user is holding communications device 300 in their right hand. Edge sensors within communications device 300 detect fingers on the left side of communications device 300, and the portrait mode orientation is detected by an accelerometer in communications device 300. Additionally, communications device 300 detects the user's palm with sensor 330 at the bottom of communications device 300. In order to horizontally scroll on touchscreen 302, the user presses two of their fingers against the left side of communications device 300 at sensing points 320 and 322. Sensing points 320 and 322 are specific areas of the edge sensors of communications device 300. To scroll horizontally, the user moves their thumb downward along sensor point 328 of the edge sensor on the right side of communications device 300 for a scroll to the right or upward along sensor point 328 of the edge sensor on the right side of communications device 300 for a scroll to the left. The horizontal scroll change is proportional to the distance thumb 328 has been moved along the edge sensor. The presence of fingers may be differentiated from finger presses based upon the amount of pressure applied, the location of the presses as determined by the edge sensors, sensor points, etc.

If the user is holding the communications device in their left hand, the communications device similarly detects this based upon the placement of the user's fingers. With the device in the user's left hand, the finger placement for horizontal scrolling is the same, but with positions and motions on the left side moved to the right side, and vice versa.

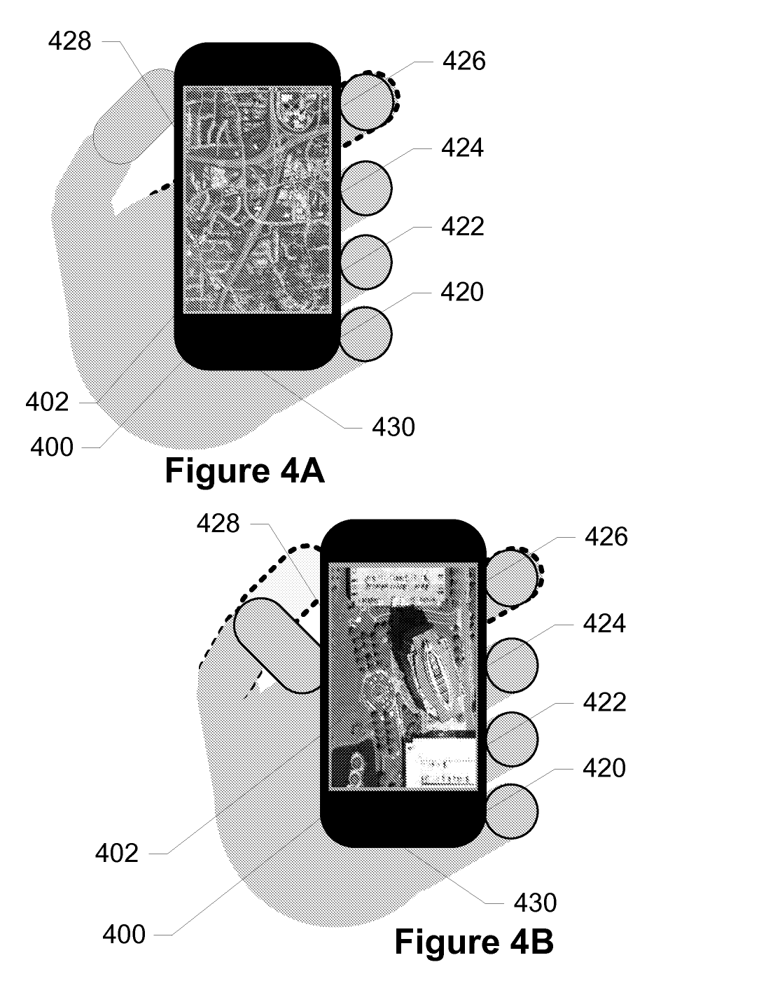

FIGS. 4A and 4B show motions and positions for zooming in on a touchscreen 402 of communications device 400, according to an exemplary embodiment of the present invention. In this embodiment, a user is holding communications device 400 in the user's left hand. Edge sensors within communications device 400 detect fingers on the right side of communications device 400, and the portrait mode orientation is detected by an accelerometer in communications device 400. Additionally, communications device 400 detects the user's palm with sensor 430 at the bottom of communications device 400. In order to zoom in or out on touchscreen 402, the user presses their fingers against the right side of communications device 400 at sensing points 420, 422, 424, and 426. Sensor points 420, 422, 424, and 426 are specific areas of the edge sensors of communications device 400. To zoom in, the user moves their thumb downward along sensor point 428 of the edge sensor on the left side of communications device 400. To zoom out, the user moves their thumb upward along sensor point 428 of the edge sensor on the left side of communications device 400. The change in magnification is proportional to the distance the user's thumb has been moved along sensor point 428 of the edge sensor. The presence of fingers may be differentiated from finger presses based upon the amount of pressure applied, the location of the presses as determined by the edge sensors, sensor points, etc.

If the user is holding the communications device in their right hand, the communications device similarly detects this based upon the placement of the user's fingers. With the device in the user's right hand, the finger placement for zooming is the same, but with positions and motions on the right side moved to the left side, and vice versa.

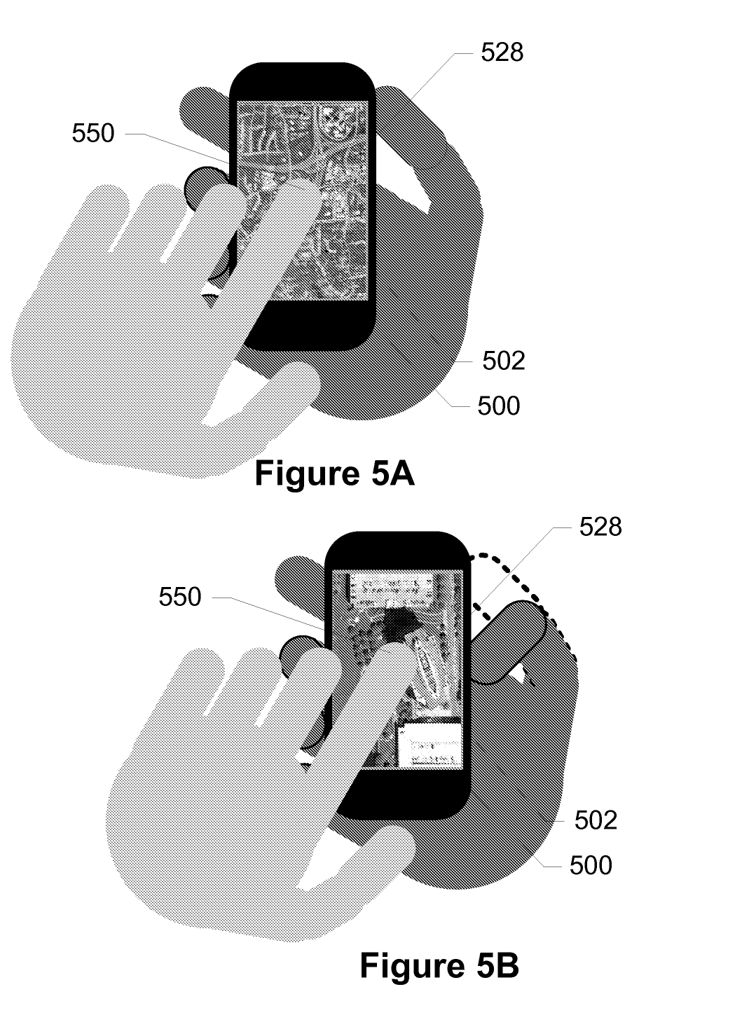

FIGS. 5A and 5B show motions and positions for zooming in on a touchscreen 502 of communications device 500, according to an exemplary embodiment of the present invention. In this embodiment, a user is holding communications device 500 in the user's right hand. Edge sensors within communications device 500 detect fingers on the right side of communications device 500, and the portrait mode orientation is detected by an accelerometer in communications device 500. Additionally, communications device 500 detects the user's palm with sensor 530 at the bottom of communications device 500. In order to zoom in or out on touchscreen 502, the user presses a finger of their left hand against a point 550 at the center of touchscreen 502. Alternatively, the user can press a finger against any place on touchscreen 502 to zoom in or out on that place. These touches are detected by touchscreen 502 of communications device 500. To zoom in, the user moves their thumb downward along sensing point 528 of the edge sensor on the right side of communications device 500. To zoom out, the user moves their thumb upward along sensing point 528 of the edge sensor on the right side of communications device 500. The change in magnification is proportional to the distance the user's thumb has been moved along sensing point 528 of the edge sensor. The presence of fingers may be differentiated from finger presses based upon the amount of pressure applied, the location of the presses as determined by the edge sensors, etc.

If the user is holding the communications device in their left hand, the communications device similarly detects this based upon the placement of the user's fingers. With the device in the user's left hand, the finger placement for zooming is the same, but with positions and motions on the right side by the right hand moved to the left side, and the pressing of the touchscreen by the left hand done by the right hand.

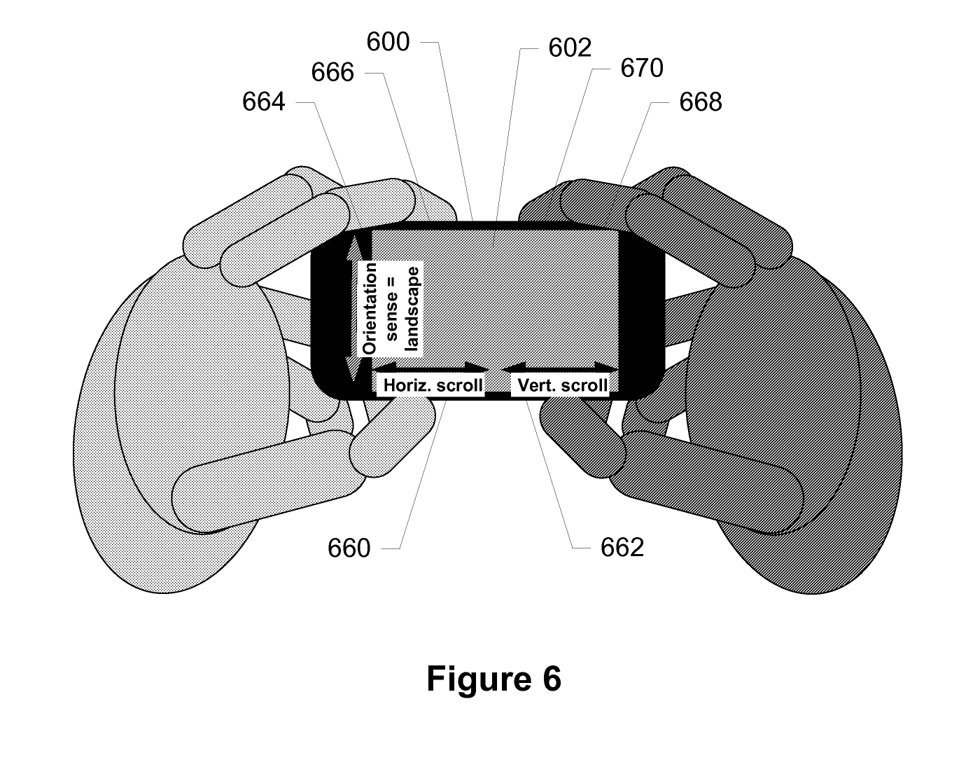

FIG. 6 shows motions and positions for scrolling on a touchscreen 602 of communications device 600, according to an exemplary embodiment of the present invention. In this embodiment, a user is holding communications device 600 in both hands in a landscape orientation. This is determined by a processor in communications device 600 using readings generated by an accelerometer in communications device 600 to detect the orientation of communications device 600. Additionally, edge sensors on communications device 600 detect the user's thumbs at the bottom of communications device 600, the bottom being the bottom in this orientation, and fingers of each hand on top of communications device 600. In order to scroll horizontally on touchscreen 602, the user presses two fingers of their left hand against sensor points 664 and 666 at the top left of communications device 600 and slides their left thumb to the right or left along sensor point 660 at the left portion of the bottom edge of communications device 600. Sliding the user's left thumb to the right scrolls right while sliding the user's left thumb to the left scrolls left. In order to scroll touchscreen 602 vertically, the user presses two fingers of their right hand against sensor points 668 and 670 at the top right of communications device 600 and slides their right thumb to the right or left along sensor point 662 at the right portion of the bottom edge of communications device 600. Sliding the user's right thumb to the right scrolls up while sliding the user's right thumb to the left scrolls down. Each of these touches and motions is detected by the edge sensor of communications device 600. The change in magnification is proportional to the distance the user's right thumb or left thumb has been moved along sensor points 660 and 662 of the edge sensor. The presence of fingers may be differentiated from finger presses based upon the amount of pressure applied, the location of the presses as determined by the edge sensors, etc.

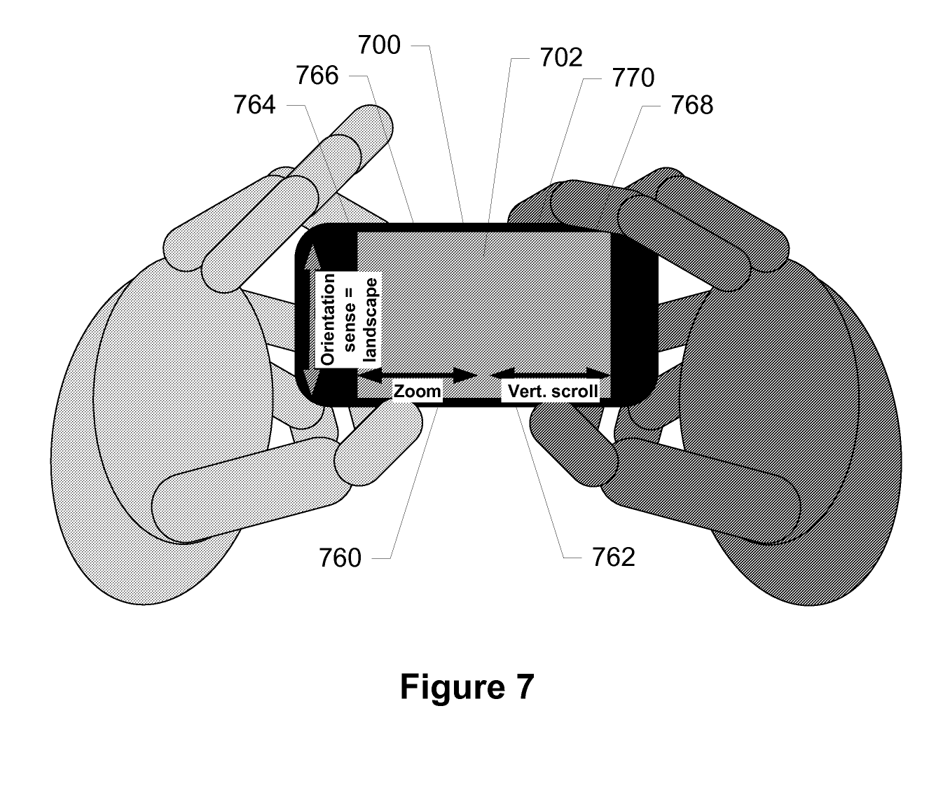

FIG. 7 shows motions and positions for scrolling and zooming in on a touchscreen 702 of communications device 700, according to an exemplary embodiment of the present invention. In this embodiment, a user is holding communications device 700 in both hands in a landscape orientation. This is determined by communications device 700 as an accelerometer in communications device 700 detects the orientation of communications device 700. Additionally, edge sensors on communications device 700 detect the user's thumbs at the bottom of communications device 700, the bottom being the bottom in this orientation, and fingers of each hand on top of communications device 700. In order to zoom in or out on touchscreen 702, the user presses one finger of their left hand against sensor point 764 at the top left of communications device 700 and slides their left thumb to the right or left along sensor point 760 at the left portion of the bottom edge of communications device 700. Sliding the user's left thumb to the right zooms in while sliding the user's left thumb to the left zooms out. In order to scroll touchscreen 702 vertically, the user presses two fingers of their right hand against sensor points 768 and 770 at the top right of communications device 700 and slides their right thumb to the right or left along sensor point 762 at the right portion of the bottom edge of communications device 700. Sliding the user's right thumb to the right scrolls up while sliding the user's right thumb to the left scrolls down. Each of these touches and motions is detected by the edge sensor of communications device 700. The change in magnification is proportional to the distance the user's right thumb or left thumb has been moved along sensor points 760 and 762 of the edge sensor. The presence of fingers may be differentiated from finger presses based upon the amount of pressure applied, the location of the presses as determined by the edge sensors, etc.

In embodiments of the present invention, the user may also zoom using the right hand while scrolling horizontally with the left hand. This entails the user pressing one finger of their right hand against sensor point 768 at the top right of communications device 700 while sliding their right thumb along sensor point 762 at the right portion of the bottom edge in order to zoom in and out and pressing two fingers of their left hand against sensor points 764 and 766 at the top left of communications device 700 while sliding their left thumb along sensor point 760 at the left portion of the bottom edge in order to scroll horizontally.

Using combinations of the finger placements and motions for FIGS. 2-7, a user can easily switch back and forth from vertically scrolling, horizontally scrolling, zooming, etc. The user or device may also program different finger configurations for these and other interface functions. These configurations may be based upon frequently used interface functions, any handicaps the user may have, etc. For instance, a user missing a finger may change configurations such that they are able to use certain interface functions that otherwise would have required that finger. These configurations are stored on a memory of the communications device.

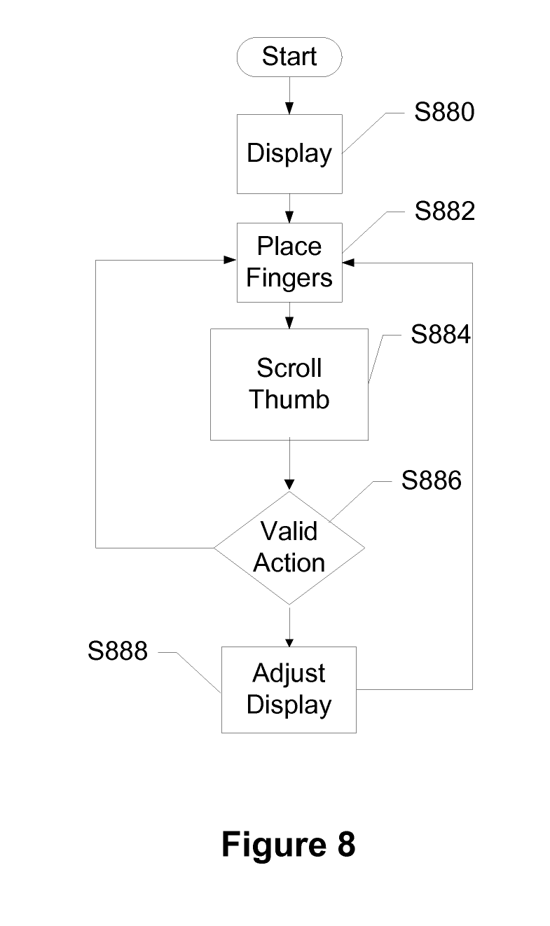

FIG. 8 shows a method of controlling a user interface, according to an exemplary embodiment of the present invention. In this embodiment a touchscreen of a communications device displays an image, text, etc. S880. A user places their fingers on the communications device based upon the control they wish to perform S882. These controls are seen, for example, in the various embodiments presented in FIGS. 2-7. With the fingers placed according to the desired control, the user scrolls or slides their thumb along the edge of the communications device in order to control the interface S884. Sliding the thumb in one direction versus the opposite direction causes the communications device to perform an action in one direction versus the other direction, such as zooming in or zooming out. A processor of the communications device determines whether or not a valid action has been performed S886. If a valid action has not been performed, the user must re-place their fingers to attempt the control again S882. If the action is determined to be valid, the display is adjusted according to the performed control S888. After the control is performed, the user may re-place their fingers to begin a new control S882.

The method may take the form of instructions on a computer readable medium. The instructions may be code segments of a computer program. Computer-readable refers to information encoded in a form which can be scanned or sensed by a machine or computer and interpreted by its hardware and software. Thus, a computer-readable medium includes magnetic disks, magnetic cards, magnetic tapes, magnetic drums, punched cards, optical disks, barcodes, magnetic ink characters, and any other tangible medium capable of storing data.

All of the aforementioned combinations should be customizable to suit the user. In some cases it may even be advantageous to provide input models suited to various disabilities and/or missing fingers, thus improving the usefulness of the device for the largest possible user base. Beyond initial settings, this mechanism should be automatic, autonomous and much more user friendly than the alternatives.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A communications device with an interface controllable by edge and finger sensing, comprising:
a processor;
a memory in communication with the processor;
an accelerometer in communication with the processor; and
an edge sensor in communication with the processor,
wherein the edge sensor detects a plurality of touches and motions by a user and compares the plurality of touches and motions with a stored set of touches and motions in the memory, and
wherein a match between the plurality of touches and motions and the stored set of touches and motions results in an interface function.

2. The device in claim 1, wherein the edge sensor further comprises a plurality of sensing points.

3. The device in claim 2, wherein the plurality of sensing points include a plurality of known locations along the edge sensor such that a change in capacitance of a specific sensing point results in the edge sensor ascertaining a location of contact.

4. The device in claim 1, wherein the processor uses an orientation reading from the accelerometer to determine whether the communications device should be in a portrait mode or a landscape mode.

5. The device in claim 1, wherein a placement of the user's fingers determines the interface function, and wherein sliding the user's thumb determines the direction of the interface function.

6. The device in claim 1, wherein the interface function is scrolling vertically.

7. The device in claim 1, wherein the interface function is scrolling horizontally.

8. The device in claim 1, wherein the interface function is zooming in and zooming out

9. The device in claim 1, further comprising a touch processor in communication with the processor, the touch processor receiving inputs from the edge sensor.

10. The device in claim 1, further comprising a transceiver in communication with and operable by the processor.

11. The device in claim 10, wherein the transceiver is one of radio frequency technology (RF), BLUETOOTH, WiFi, and radio-frequency identification (RFID).

12. A method for controlling an interface of a communications device, the method comprising:
determining an orientation of the communications device;
touching a plurality of locations around an edge sensor of the communications device, wherein the plurality of locations and the orientation determines a control function;
creating a motion along a sensor point;
detecting the plurality of locations touched around the edge sensor and the motion along the sensor point;
determining that the touches and the motion correspond to a valid control function; and
adjusting a display according to the valid control function.

13. The method of claim 12, wherein the orientation is one of landscape and portrait.

14. The method of claim 13, wherein the landscape orientation allows the user to perform multiple adjustments.

15. The method of claim 12, wherein determining the orientation is performed by a processor in conjunction with an accelerometer in the communications device.

16. The method of claim 12, wherein the control function is a horizontal scroll.

17. The method of claim 12, wherein the control function is a vertical scroll.

18. The method of claim 12, wherein the control function is zooming in and zooming out.

19. The method of claim 12, wherein determining the valid function is accomplished by comparing the touches and movements with a sequence of touches and movements stored on a memory.

20. The method of claim 12, wherein the display is a touchscreen, the method further comprising zooming in on a point is by touching the point while moving along the sensor point.

21. A computer-readable medium containing instructions for controlling an interface of a communications device, the instructions comprising:
a first code segment for determining an orientation of the communications device;
a second code segment for sensing a plurality of touches at a plurality of locations around an edge sensor of the communications device, wherein the plurality of locations and the orientation determines a control function;
a third code segment for sensing a motion along a sensor point;
a fourth code segment for detecting the plurality of locations touched around the edge sensor and the motion along the sensor point;
a fifth code segment for determining that the touches and the movement correspond to a valid control function; and
a sixth code segment for adjusting a display according to the valid control function.
